(19) United States
(12) Patent Application Publication
(10) Pub. No.: US 2017/0334752 A1
(43) Pub. Date: Nov. 23, 2017

(54) SULFATE REDUCTION IN FLUE GAS DESULFURIZATION SYSTEM BY BARIUM PRECIPITATION

(71) Applicant: AECOM Technical Services, Inc., Austin, TX (US)

(72) Inventor: Gregory Phillip Behrens, Jonestown, TX (US)

(73) Assignee: AECOM Technical Services, Inc., Austin, TX (US)

(21) Appl. No.: 15/599,991

(22) Filed: May 19, 2017

Related U.S. Application Data
(60) Provisional application No. 62/338,846, filed on May 19, 2016.

(51) Int. Cl. C02F 1/52; C02F 1/00; C02F 103/34; C02F 101/10

(52) U.S. Cl. CPC C02F 1/5236; C02F 1/004; C02F 2103/34; C02F 2101/101

(57) ABSTRACT

A process for treating a flue gas desulfurization discharge stream containing dissolved sulfates is presented. Soluble barium compounds, such as barium chloride or barium carbonate are added to the stream in lieu of the traditional two-step lime/carbon dioxide process. The barium compounds cause the sulfate to precipitate as insoluble barium sulfate. The barium sulfate solids settle out of the discharge stream and can be filtered from the process water. The use of soluble barium compounds eliminates the need for subsequent pH adjustment, results in lowering calcium and magnesium concentrations in the discharge stream, and decreases scaling potential in downstream equipment.

### PRIORITY STATEMENT UNDER 35 U.S.C. §119 & 37 C.F.R. §1.78

The present non-provisional application claims priority based upon prior U.S. Provisional Patent Application Ser. No. 62/338,846 filed May 19, 2016 in the name of Gregory Phillip Behrens entitled “SULFATE REDUCTION IN FLUE GAS DESULFURIZATION SYSTEM BY BARIUM PRECIPITATION,” the disclosure of which is incorporated herein in its entirety by reference as if fully set forth herein.

### BACKGROUND OF THE INVENTION

Several industrial processes, including the conversion of coal to power, include scrubbers for removal of acid gases, such as hydrochloric acid and sulfur dioxide. Hydrochloric acid is typically removed by dissolution in water and the resulting liquor is then neutralized with a substance such as lime. Sulfur dioxide is typically removed with a wet flue gas desulfurization (FGD) scrubber, wherein the flue gas containing sulfur dioxide is placed in contact with water containing an alkaline material, such as limestone, lime, magnesium compounds or sodium compounds. In the scrubber, the alkaline material reacts with the sulfur dioxide to form a neutral compound such as calcium sulfate dihydrate (i.e. gypsum).

Powder River coal has distinct differences from Eastern bituminous coal. It has lower heating value, requiring more tonnage per unit of energy production. It contains much lower sulfur levels (˜5 to 10 times less), about half the ash content (˜5%) and very much lower chlorine amounts (˜10 to 100 times less) than bituminous coal. The lower sulfur concentration mean that the flue gas desulfurization systems can meet low emission levels with less slurry recirculation than at high sulfur concentrations. The low chloride level positively impacts the chemical composition of the scrubbing liquor. Calcium sulfite/sulfate is a sparingly soluble material that forms when limestone (calcium carbonate) reacts with the sulfur dioxide scrubbed from the flue gas.

Magnesium is also present in the limestone; however the salts it forms in FGD systems are generally very soluble. To maintain ionic neutrality in the liquid, the magnesium requires an anion to remain in solution. Since the amount of chloride contributed by the coal is relatively low, the magnesium keeps sulfite or sulfate ions in solution above the concentrations possible if just calcium was present. The extra sulfite, to the extent it is not oxidized in the absorbers, helps remove sulfur dioxide making the liquor more alkaline. However, the excess sulfate in solution is the oftentimes the reason for operational problems such as gypsum scale formation. These soluble ions need to be purged from the system to prevent performance degradation and materials corrosion. One purge treatment method uses constructed wet lands to reduce selenium and other trace constituents. However, wetlands cannot remove sulfates and thus a separate process may be required to remove sufficient amounts of sulfate to meet the water discharge limits.

The largest mass transfer that occurs in all FGD systems is the evaporation of water to cool the flue gas. The transfer is on the order of hundreds of thousands of pounds per hour versus tens of thousands pounds of sulfur and carbon dioxide. The effect of this evaporation is a concentration of the dissolved ions in the scrubbing liquor. Those salts (ion pairs) that exceed their solubility limit are continuously precipitating as a solid material (calcium sulfate dihydrate in this case) that is removed from the system via the primary cyclones and rotary filters and made available for sale. The soluble salts (primarily comprised of sodium, magnesium, chloride, and sulfate) will increase in concentration if not controlled by a bleed stream. High chloride levels cause corrosion issues with the metallurgy of the system. The actual problem point is a function of the specific metallurgy, pH, and oxidation reduction potential. Some scrubber liquor (with salts) exits with the dewatered solids as free moisture in the filter cake. If that amount is not adequate, a separate purge stream from the system is required to control the soluble salt concentration. The purge flow can vary from about 20 to 1000 gpm with a chloride concentrations ranging typically from 2,000 to over 30,000 mg/L, depending on the size of the plant and coal composition.

FGD purge water has been specifically addressed in the recently promulgated Electric Utility Effluent Limitations Guidelines (ELG) by the Environmental Protection Agency. As existing utility National Pollutant Discharge Emission System permits are renewed, much more stringent discharge limits will be imposed. Currently, plants may have to treat the purge water to meet sulfate discharge limits due to state requirements. The FGD purge stream is typically treated with physical/chemical technology prior to subsequent biological processing, (e.g., discharge to engineered wetlands or further processing in reactor vessels). Traditional sulfate removal processes experience severe scaling downstream of the final pH adjustment step.

The table in FIG. 1 provides an analysis of scrubber liquor. The composition was analyzed using an equilibrium model developed for chemical reactions. Two of the steps in a current wastewater treatment system have been simulated using this model to predict the formation of solid materials, which indicates possible scale formation.

The purge or discharge water, containing a large amount of dissolved sulfate, is mixed with enough lime in Step 1 to lower the sulfate concentration below 3,000 mg/L. Note that gypsum and magnesium hydroxide precipitate in this step as solid materials. The resulting liquor, at pH 12.5, must then be neutralized before discharge. Common acids for pH reduction include sulfuric acid (which is not practical in this case since that would reintroduce sulfate), hydrochloric acid, and carbon dioxide. In this example, carbon dioxide is added in Step 2, which results in the precipitation of calcite (calcium carbonate). If adequate reaction time is not provided, calcite precipitation continues to occur in downstream piping, pumps, and even in wetlands, retarding flow and infiltration. It is this formation mechanism that may cause severe scaling and operational problems at facilities. Note that adding more CO₂ for acidification is not feasible as the gas will equilibrate to the atmospheric concentration (˜400 ppmv) once removed from pressure. Any higher dose would escape from the liquid as wasted CO₂.

There is a need, therefore, for a system and method for removing sulfates from a flue gas desulfurization discharge stream which provides:
insignificant or no scale formation and, preferably, the capability to dissolve any existing calcium carbonate scale;
maximum reuse of existing equipment with minimal capital expenses;
similar operational requirements to existing FGD systems;
equivalent or lower chemical costs than existing FGD systems;
production of saleable gypsum byproduct;
minimal environmental effects;
easily evaluated concept and feasibility analysis; and
minimal cost to abandon as future regulations are implemented.

### SUMMARY OF THE INVENTION

As previously discussed, lime is typically used to lower the amount of sulfate in an FGD discharge stream and carbon dioxide is then used to neutralize the pH of the discharge stream. However, there are limits to the amount of carbon dioxide that can be added to the stream, thereby reducing the effectiveness of the process and causing calcite to form within the system. Various embodiments of the present invention include the use of soluble barium compounds such as barium chloride or barium carbonate, both of which result in equimolar reduction of sulfate concentrations within the discharge stream. The addition of these barium compounds causes the sulfate to precipitate as barium sulfate, which is very insoluble. The barium sulfate solids settle out of the discharge stream and can be filtered from the process water. The use of soluble barium compounds does not require any subsequent pH adjustment, results in lowering calcium and magnesium concentrations in the discharge stream, and decreases scaling potential in downstream equipment.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the present invention, and the advantages thereof, reference is now made to the following descriptions taken in conjunction with the accompanying drawings, in which:

FIG. 1 provides a table with an analysis of scrubber liquor using the two-step process known in the prior art;

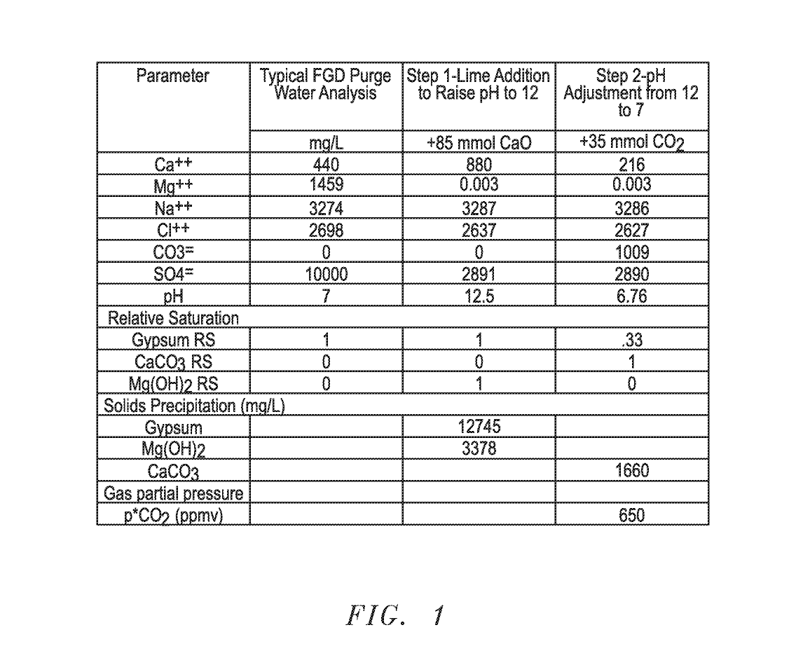

FIG. 2 depicts one embodiment of the sulfate removal process of the present invention having a barium reagent storage and feed system, a mixing vessel for the reaction to occur, and a solids separation device to remove the precipitated barium sulfate solids from the purge stream; and

FIG. 3 provides a table with an analysis of scrubber liquor using one embodiment of the sulfate removal process of the present invention.

### DESCRIPTION OF THE PREFERRED EMBODIMENTS

The present invention is directed to improved methods and systems for, among other things, sulfate reduction in a flue gas desulfurization discharge stream by the addition of barium. The configuration and use of the presently preferred embodiments are discussed in detail below. It should be appreciated, however, that the present invention provides many applicable inventive concepts that can be embodied in a wide variety of contexts other than sulfate reduction in a flue gas desulfurization system by barium precipitation. Accordingly, the specific embodiments discussed are merely illustrative of specific ways to make and use the invention, and do not limit the scope of the invention. In addition, the following terms shall have the associated meaning when used herein:

“flue gas desulfurization” or “FGD” means any process in which sulfur dioxide is reduced in, or removed from, exhaust flue gases of fossil-fuel power plants or from the emissions of other sulfur oxide emitting processes;

“lime,” when referring to the addition of lime to a flue gas desulfurization discharge stream, can include limestone, magnesium compounds, sodium compounds or other chemicals or compounds that react with sulfur dioxide in the stream to create a sulfite compound;

“purge stream” or “discharge stream” means any fluid stream emitted from a flue gas desulfurization process.

Although lime and carbon dioxide are traditionally used to lower sulfate concentrations in FGD system purge waters, it is possible to use other chemicals as well. Embodiments of the present invention include the addition of soluble barium compounds such as barium chloride (BaCl₂) or barium carbonate (BaCO₃), both of which result in equimolar reduction of sulfate concentrations. The addition of BaCl₂ or BaCO₃ precipitates the sulfate anions as the very insoluble barium sulfate (BaSO₄). The BaSO₄ solids settle and are filtered from the process water and recycle. In this process, calcium carbonate (CaCO₃) scaling resulting from the addition of carbon dioxide (CO₂) for pH control can be avoided.

Moreover, the use of BaCl₂ does not require any subsequent pH adjustment. The use of BaCO₃ results in lowering calcium and magnesium concentrations, decreasing scaling potential in downstream equipment. The incremental capability of reducing the sulfate concentration makes this attractive to any subsequent processing step that produces a concentrated waste stream (e.g. reverse osmosis, ion exchange, ultrafiltration, brine concentration) that experiences gypsum or calcite scale formation.

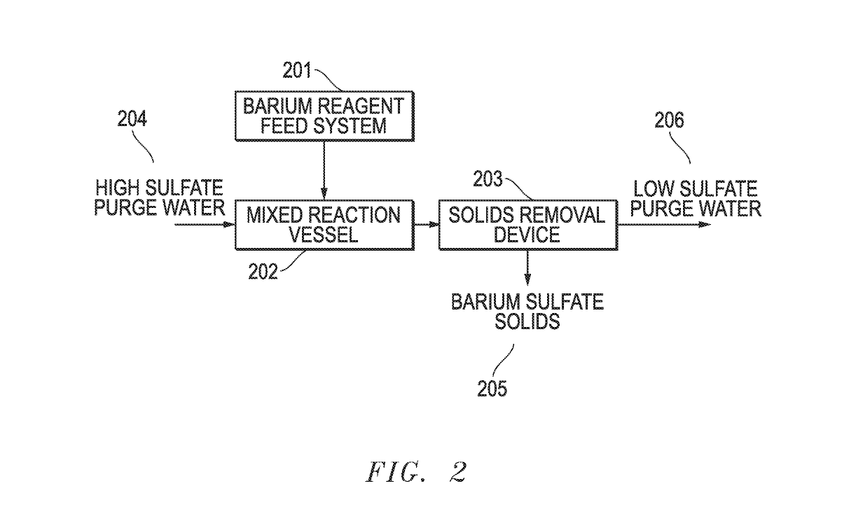

Referring now to FIG. 2, embodiments of the present invention include a barium reagent feed system 201 which could include a silo for storage of dry reagent, and/or a tank for slurry or liquid solution, a feed system that may be manually or automatically controlled that adds the desired amount of reagent to the high sulfate purge stream 204, a mixed reactor vessel 202 that allows sufficient time for reaction between barium and sulfate to occur, and a solids removal device 203 that will separate the low sulfate purge stream 206 from the barium sulfate solids 205. Additional reagents may be added to control pH or other substances in the purge water as is known in the art. In some instances, flocculants, polymers, or coagulants are added to the discharge stream to assist in the solids separation, filtration and removal from the process discharge water stream.

Other embodiments of the process shown in FIG. 2 include the combined use of the barium reagent with other chemical reactions, so that existing waste water treatment equipment can be used with minimal modifications. The precipitation of barium sulfate is essentially equimolar to the barium dose added when an excess of sulfate is present. Since the other common cations (e.g., magnesium, sodium, potassium, and calcium) present in FGD purge water do not have a low solubility product, the sulfate reduction occurs independently of other reactions (hydroxide precipitation, mercury complexation, selenium reduction, etc.). This permits sulfate reduction to be employed at a minimal additional capital cost with existing purge water treatment systems.

Those skilled in the art will appreciate that embodiments of the present invention are particularly effective when used with FGD purge streams that do not contain gypsum solids. In those instances in which the FGD purge stream does contain gypsum solids, a reduction in the liquid phase sulfate level by barium precipitation would lower the relative saturation of the stream due to the common ion effect, thereby causing solid phase gypsum to dissolve to re-attain equilibrium.

The precipitated barium sulfate solids will produce slurry that can be independently dewatered and recycled or disposed. Alternately, the solids are at chemical equilibrium and will not re-dissolve if returned to a gypsum containing slurry. This offers an option for disposal with the bulk gypsum/FGD waste.

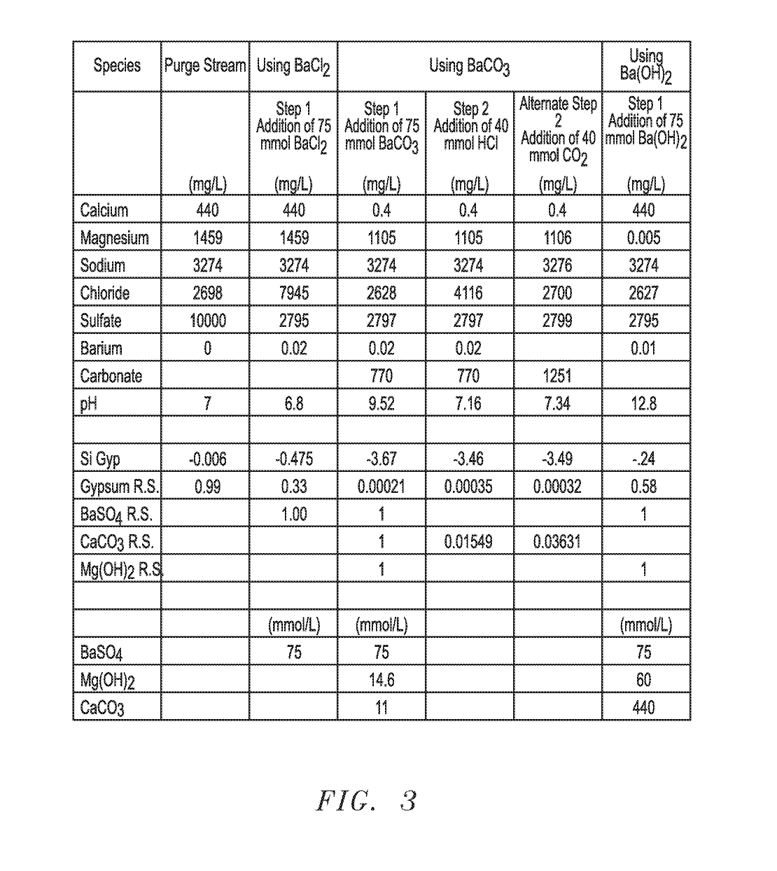

In an example case for one embodiment of the process of the present invention, rather than adding lime to the high-sulfate containing purge stream, BaCl₂ was added to the stream. The results are shown in the table included in FIG. 3. The chemical makeup of the purge stream is shown in column 1 of the table. The first column of the table identifies the chemical species present in the purge stream and the second column shows the amount in mg/liter of each of the species present. The third column of the table labeled “Using BaCl₂” shows the results in mg/liter for BaCl₂ addition to the purge stream. The results show an increase in the level of chloride and a reduction in the level of sulfate while maintaining a pH of 6.8. As a result, this process does not require acidification for neutralization while reducing the sulfate to low levels which avoids scaling in the downstream process equipment.

The fourth, fifth and sixth columns of the table in FIG. 3 labeled “Using BaCO₃” show a two-step process in which BaCO₃ is added to the purge stream which reduces the magnesium, calcium and sulfate, but increases the pH to 9.52. The addition of HCl in the second step brings the pH down to a neutral 7.16 while slightly increasing the chloride level. As an alternative to the addition of HCl, CO₂ can be added to the stream which also effectively reduces the pH to a neutral 7.34 without a significant increase in the chloride level or the formation of calcite scale.

Referring now to the seventh column of the table in FIG. 3 labeled “Using Ba(OH)₂” where Ba(OH)₂ is added to the purge water stream. This process lowers the sulfate concentration significantly, thus avoiding scaling in downstream equipment, and it also substantially lowers the level of chloride in the stream, but the pH is increased to 12.8. In order to reduce the pH, either HCl or CO₂ could be added. However, the addition of HCl would have the undesirable side effect of increasing the chloride concentration and the addition of CO₂ would result in the precipitation of calcite. Therefore, it does not appear that barium hydroxide would be suitable for general use in this particular embodiment of the process, but it may be applicable in certain industrial conditions.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of methods for sulfate reduction in a flue gas desulfurization system known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

We claim:

1. A method for reducing sulfate concentration of a flue gas desulfurization discharge stream, comprising:
processing a discharge stream from a flue gas desulfurization system, wherein the discharge stream contains dissolved sulfate;
adding one or more barium compounds to the discharge stream; and
reacting the barium compounds with the dissolved sulfate to form barium sulfate, thereby reducing concentration of the dissolved sulfate in the discharge stream.

2. The method of claim 1, wherein the one or more barium compounds include barium chloride or barium carbonate.

3. The method of claim 1, wherein the barium sulfate is removed from the discharge stream by filtration.

4. The method of claim 1, wherein the barium sulfate is removed from the discharge stream by a combination of settling and filtering.

5. The method of claim 1, wherein after the barium sulfate is removed from the discharge stream, the acidity of the discharge stream is adjusted to be between a pH of 6 and a pH of 9.

6. The method of claim 1, wherein flocculants, polymers, or coagulants are added to the discharge stream to assist in solids separation, filtration and removal from the discharge stream.

7. The method of claim 1, wherein the barium sulfate is recovered for recycle, reuse, or sale.

8. The method of claim 1, wherein the barium sulfate is combined with gypsum for disposal or sale.

9. A system for reducing sulfate concentration of a flue gas desulfurization discharge stream, comprising:
a reaction vessel receiving a discharge stream having dissolved sulfate from a flue gas desulfurization system and receiving a barium reagent feed stream; and
a solids removal device located downstream from the reaction vessel, wherein the barium reagent reacts with the dissolved sulfate in the reaction vessel to form barium sulfate, thereby reducing concentration of the dissolved sulfate, and the discharge stream passes through the solids removal device to remove the barium sulfate.

10. The system of claim 9, wherein the barium reagent includes barium chloride or barium carbonate.

11. The system of claim 9, wherein the solids removal device is a primary cyclone or rotary filter.

12. The system of claim 9, wherein after wherein the barium sulfate is removed from the discharge stream, the acidity of the discharge stream is adjusted to be between a pH of 6 and a pH of 9.

13. The system of claim 9, wherein flocculants, polymers, or coagulants are added to the discharge stream to assist in solids separation, filtration and removal of barium sulfate from the discharge stream.

14. The system of claim 9, wherein the barium sulfate is recovered for recycle, reuse, or sale.

15. The system of claim 9, wherein the barium sulfate is combined with gypsum for disposal or sale.
